(19) United States
(12) Patent Application Publication
(10) Pub. No.: US 2019/0304766 A1
(43) Pub. Date: Oct. 3, 2019

(54) GLOW DISCHARGE SYSTEM, ION EXTRACTION STRUCTURE THEREOF, AND GLOW DISCHARGE MASS SPECTROSCOPE

(71) Applicant: Glow Technology KK, Tokyo (JP)

(72) Inventor: Takahiro TAKAHASHI, Tokyo (JP)

(73) Assignee: Glow Technology KK, Tokyo (JP)

(21) Appl. No.: 16/104,530

(22) Filed: Aug. 17, 2018

(30) Foreign Application Priority Data
Apr. 3, 2018 (JP) 2018-71271

(51) Int. Cl. H01J 49/10; H01J 49/06; H01J 49/04

(52) U.S. Cl. CPC H01J 49/10; H01J 49/0459; H01J 49/067

(57) ABSTRACT

There is provided a glow discharge mass spectroscope having a higher analytical sensitivity by increasing an amount of extracted ion beams without a significant change in device construction and drive conditions of conventional glow discharge systems. An extraction plate 25 that is disposed at an ion extraction port of a discharge cell 20 and functions as an extraction electrode includes a first plate 26 that has a projection 26a projected toward a discharge region 27 in an opening 25a and that is disposed on the discharge region 27 side, and a second plate 28 that is connected to the first plate 26 in an outer circumferential edge and that is disposed with a gap provided between the first plate 26 and the second plate 28.

### TECHNICAL FIELD

The present invention relates to a glow discharge system, an ion extraction structure thereof, and a glow discharge mass spectroscope using the glow discharge system.

### BACKGROUND ART

A glow discharge mass spectroscope (GDMS) is known as an analyzer for various solid samples such as metals, semiconductors, and insulating materials. Such analyzer is a device that sputters a surface of a solid sample utilizing glow discharge and measures ionized constituent atoms of the solid sample with a mass spectrometer.

The analyzer has a glow discharge system in which, as disclosed in Patent Literature 1, a solid sample is placed so that a surface of the solid sample is exposed within a discharge cell, an inert gas is introduced into the discharge cell to generate glow discharge by which the solid sample is sputtered, and discharged atoms are ionized within the discharge cell, followed by extraction of ionized atoms as ion beams through an opening formed in the discharge cell.

### Prior Art Reference

### Patent Literature

Patent Literature 1: Japanese Patent Application Laid-open No. 2017-220360

### SUMMARY OF THE INVENTION

### Problem to be Solved by the Invention

In a glow discharge mass spectroscope, what is desired for an enhancement in analytical sensitivity is to increase a beam (ion) amount of ion beams extracted from the glow discharge system.

An object of the present invention is to provide a glow discharge mass spectroscope having a higher analytical sensitivity by increasing an amount of extracted ion beams without a significant change in device construction and drive conditions of a conventional glow discharge system.

### Means for Solving the Problem

According to a first aspect of the present invention, there is provided an ion extraction structure of a glow discharge system used for a glow discharge mass spectroscope, the glow discharge system comprising:

an electroconductive cell body that forms a discharge region; and

an electroconductive extraction plate that is connected to the cell body with at least an insulating member provided between the cell body and the extraction plate and that has an ion extraction port, wherein

the extraction plate includes a first plate and a second plate that are connected to each other in an outer circumferential edge,

the first plate is disposed on a side of the discharge region and has a projection that is cylindrically projected from the ion extraction port toward the discharge region, and

any one of the first plate and the second plate is projected toward the other in the outer circumferential edge, and the first plate and the second plate are disposed in a region excluding the outer circumferential edge with a gap provided between the first plate and the second plate.

The ion extraction structure of a glow discharge system of the present invention includes a preferred embodiment wherein an electroconductive slit plate having a slit and an electroconductive end plate having an opening are disposed in that order between the cell body and the insulating member, and

the end plate has a shape in which a projection that is cylindrically projected toward an outside is provided in a flat plate having the opening at a position spaced apart from the opening by a predetermined distance on an outer circumferential side.

According to a second aspect of the present invention, there is provided a glow discharge system comprising the ion extraction structure of a glow discharge system according to the above present invention.

According to a third aspect of the present invention, there is provided a glow discharge mass spectroscope comprising:

a glow discharge system that extracts ion beams of constituent atoms of a solid sample from the solid sample by glow discharge; and

a mass spectrograph that performs a mass spectroscopic analysis of ions contained in the ion beams, wherein the glow discharge system is the glow discharge system according to the above present invention.

The glow discharge mass spectroscope of the present invention includes a preferred embodiment wherein a magnetic field system that separates and selects target ions from the ion beams extracted from the glow discharge system, and an electric field system that focuses energy of ion beams selected in the magnetic field system are further provided.

### Effects of the Invention

The glow discharge system of the present invention can extract ion beams in an amount that has been significantly increased compared with the conventional glow discharge system by adopting a specific structure as an ion extraction structure. Thus, according to the present invention, an amount of ion beams to be analyzed in a mass spectrograph can be increased by slightly modifying an apparatus construction, thereby realizing a higher sensitivity in mass spectroscopic analysis of the solid sample than the prior art.

### BRIEF DESCRIPTION OF THE DRAWINGS

FIG. 1 is an end view that schematically illustrates a construction of an embodiment of the glow discharge system of the present invention and that is a cross section including a central axis of ion beams extracted from the glow discharge system.

FIG. 2 is an end view that schematically illustrates a construction of a conventional glow discharge system and that is a cross section including a central axis of ion beams extracted from the glow discharge system.

FIG. 3 is an enlarged view of the discharge cell illustrated in FIG. 1.

FIG. 4 is a graph illustrating an analysis chart of a mass spectroscopic analysis for copper using a glow discharge system of the present invention.

FIG. 5 is a graph illustrating an analysis chart of a mass spectroscopic analysis for copper using a conventional glow discharge system.

### MODE FOR CARRYING OUT THE INVENTION

Although, for the present invention, embodiments will be described in more detail appropriately with reference to the drawings, the present invention should not be construed to be limited by the following embodiments. Well-known or publicly known techniques in the technical field can be applied to portions not specifically described in the following description and portions not specifically illustrated in the drawings.

The glow discharge system of the present invention is a system for a glow discharge mass spectroscope and is characterized by an ion extraction structure thereof. The glow discharge system of the present invention includes an electroconductive cell body forming a discharge region, and an electroconductive extraction plate that is connected to the cell body with at least insulating member provided between the cell body and the extraction plate and that has an ion extraction port. The present invention is characterized in that a beam amount of ion beams extracted from the glow discharge system is significantly increased by virtue of a construction of an extraction plate including a first plate having a projection projected from an ion extraction port toward a discharge region, and a second plate with a gap provided between the first plate and the second plate at the side of the ion extraction port.

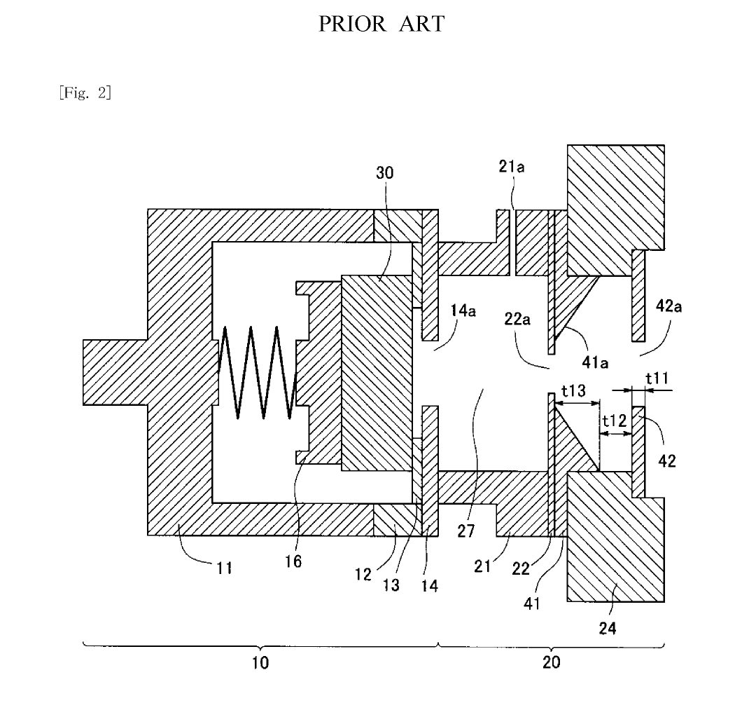

At the outset, a conventional glow discharge system is illustrated in FIG. 2. FIG. 2 is an end view that schematically illustrates a construction of a conventional glow discharge system and that is a cross section including a central axis of ion beams extracted from the glow discharge system.

The glow discharge system illustrated in FIG. 2 includes a sample holder 10 that holds a solid sample 30, and a discharge cell 20 that generates glow discharge to extract ion beams (not illustrated) from the solid sample 30.

The sample holder 10 includes a front plate 14 that has an opening 14a and that is disposed on a frame 11 with an insulating ring 12 provided between the frame 11 and the front plate 14, and a solid sample 30 is held by being pressed against a sample isolator 13 by a plunger 16 that is a holding member with one main surface of the solid sample 30 facing the opening 14a. A part of the main surface of the solid sample 30 is exposed within the opening 14a. The frame 11 and the plunger 16 are formed of an electroconductive material, for example, aluminum, the insulating ring 12 is formed of an insulating material, for example, polyether ether ketone (PEEK), the sample isolator 13 is a plate that has an opening in communication with the opening 14a, that is formed of an insulating material, for example, alumina, and the front plate 14 is formed of an electroconductive material, for example, tantalum.

The discharge cell 20 includes a cell body 21 that is cylindrical with one of openings being adjacent to an opening 14a side of a front plate 14 that is an opening of a sample holder 10, in contact with the front plat 14, while the other opening side is an ion extraction port side. The cell body 21 has a discharge region 27 in its interior and has a gas introduction hole 21a for introducing a discharge gas at a side wall. In the other opening of the cell body 21, a slit plate 22, an end plate 41, a cell mounting plate 24, and an extraction plate 42 are disposed in that order and each have an opening for extraction of ions to the outside. In the drawing, 22a denotes a slit formed in the slit plate 22. The discharge region 27 is a closed system except for the gas introduction hole 21a and the slit 22a. All of the cell body 21, the slit plate 22, and the end plate 41 are formed of an electroconductive material, for example, tantalum. The cell mounting plate 24 is an insulating member formed of an insulating material, for example, an insulating resin such as PEEK.

In the construction, an inert gas, for example, a high-purity argon gas (purity: 99.9999% or higher), is introduced through the gas introduction hole 21a into the discharge region 27, and a predetermined voltage is applied by using the solid sample 30 as a negative electrode through the frame 11 and the plunger 16, and using the cell body 21, the slit plate 22, the end plate 41, and the front plate 14 as a positive electrode. Further, the extraction plate 42 functions as an extraction electrode for extraction of ions from the discharge region 27 and sets a potential in a range of minus several tens of volts to minus 1000 volts to the cell body 21. In the discharge region 27, glow discharge is generated, ions of a discharge gas sputter a surface of the solid sample 30, emitted constituent atoms of the solid sample 30 are ionized by plasma in the discharge region 27, and ionized atoms are passed through a slit 22a and openings 41a, 42a and are extracted as ion beams.

The ion beams extracted from the glow discharge system are subjected to separation and selection of ions for analysis purposes in a magnetic field system not illustrated, the selected ion beams are subjected to beam energy focusing in an electric field system not illustrated, and a mass spectroscopic analysis for ions contained in the ion beams is performed in a mass spectrograph not illustrated to determine a composition of the solid sample 30. Double-focusing mass spectrometers are preferred as the mass spectrograph.

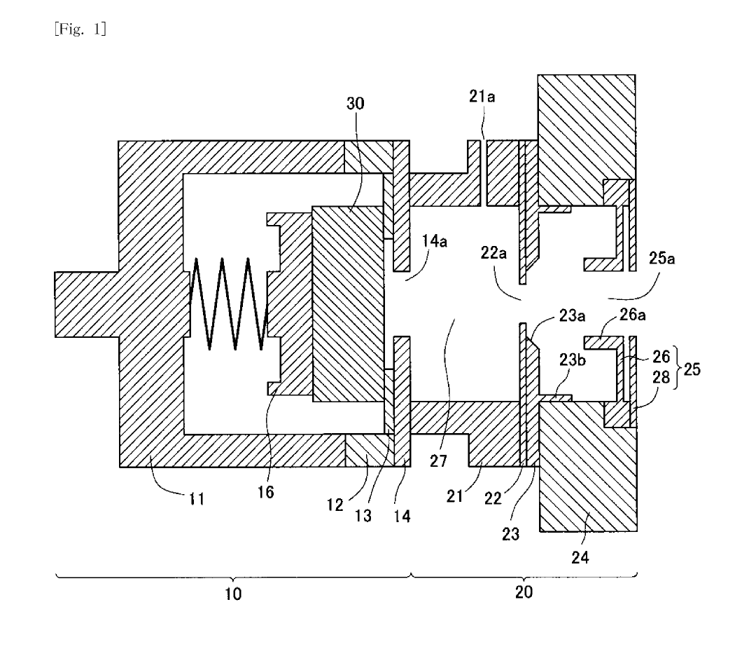

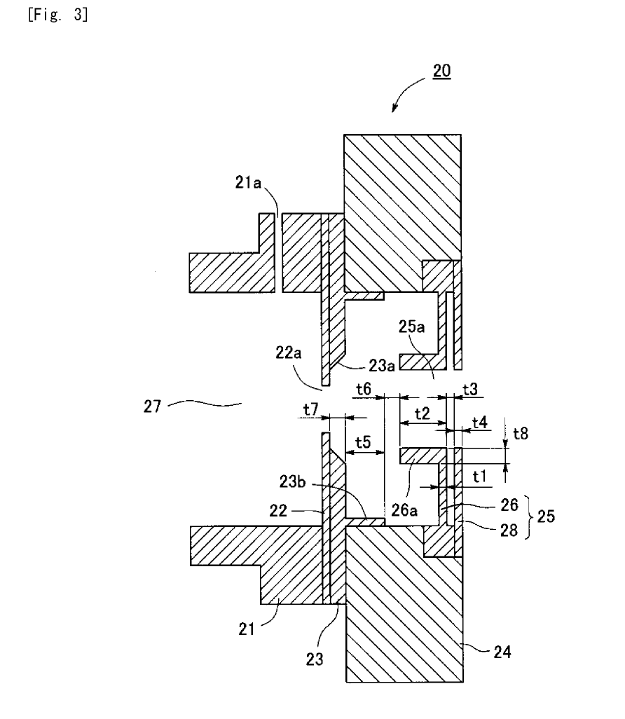

Next, the glow discharge system of the present invention will be described with reference to FIGS. 1 and 3. FIG. 1 is a diagram schematically illustrating a construction of an embodiment of a glow discharge system according to the present invention and is an end view of a cross section including a central axis of ions beams extracted from the glow discharge system, and FIG. 3 is an enlarged view of a discharge cell 20 in FIG. 1.

The glow discharge system of the present invention has the same basic construction as the conventional glow discharge system, except that, as will be described later, an ion extraction structure of the discharge cell has been changed. Thus, only portions different from the conventional glow discharge system will be described, and portions that are the same as the conventional glow discharge system will be omitted.

In the present invention, an extraction plate 25 that is an extraction electrode for ion extraction includes a first plate 26 and a second plate 28 that are connected to each other in an outer circumferential edge. The first plate 26 is disposed on a discharge region 27 side and has a projection 26a that is cylindrically projected toward the discharge region 27 from an opening 25a that is an ion extraction port. Further, any one of the first plate 26 and the second plate 28 is projected toward the other in an outer circumferential edge, and the first plate 26 and the second plate 28 are disposed with a gap t3 being provided therebetween in the region excluding the outer circumferential edge. In the embodiments illustrated in FIGS. 1 and 3, the first plate 26 is projected toward the second plate 28 side in the outer circumferential edge to form a gap t3. In the present invention, however, the second plate 28 may be projected toward the first plate 26 side in the outer circumferential edge.

A beam amount of ion beams extracted by the glow discharge system of the present invention is increased by adopting the above structure.

More preferably, the end plate 23 disposed between the slit plate 22 and the cell mounting plate 24, as illustrated in FIG. 3, has a shape in which a projection 23b that is cylindrically projected toward an outside is provided in a flat plate having the opening 23a at a position spaced apart from the opening 23a by a predetermined distance on an outer circumferential side. Specifically, in the conventional structure illustrated in FIG. 2, the end plate 41 is tapered so that an inner diameter of an opening 41a is increased from the discharge region 27 toward the outside on the whole thickness direction. On the other hand, in the present invention, a part of the taper portion is deleted to form a step.

The shape of the end plate 23 contributes to a further increase in beam amount of ion beams extracted by the glow discharge system of the present invention.

For preferred sizes of respective sites illustrated in FIG. 3, t1 is 0.4 to 0.6 mm, t2 is 1.5 to 2.5 mm, t3 is 0.4 to 0.6 mm, t4 is 0.4 to 0.6 mm, t5 is 1.5 to 2.2 mm, t6 is 0.5 to 1.5 mm, t7 is 1.4 to 1.6 mm, and t8 is 0.5 to 1.5 mm.

In the glow discharge system illustrated in FIG. 1, the solid sample 30 is a circular flat plate, all of the cell body 21, all of the projections 23b, 26a are cylindrical, and all of the opening 14a and the openings 23a, 25a are circular. Further, the slit 22a is in a linear form perpendicular to a paper surface. In the invention of the present application, the shapes are not always limited to those described above.

The glow discharge system illustrated in FIG. 1 is a flat cell-type glow discharge system that uses a flat plate-shaped solid sample 30. In the present invention, however, the glow discharge system is not limited to the flat cell-type and can also be applied to a glow discharge system of a type that analyzes a pin cell-type rod-shaped solid sample not illustrated.

In the present invention, an electric conductor or a semiconductor material can be directly analyzed as a solid sample 30. Further, for the insulator, electric conductors such as gold, graphite, and silver can be mixed as a binder with an insulator and molded into a solid sample 30, followed by analysis of the solid sample 30. Further, even solid flat plate-shaped insulators can be analyzed by using an auxiliary electrode (not illustrated) as a negative electrode to generate glow discharge.

### Examples

A glow discharge system in a glow discharge mass spectroscope “model VG9000Mk4” manufactured by Thermo Elemental limited was replaced with a glow discharge system of the present invention shown in FIG. 1, and a mass spectroscopic analysis of a solid sample of copper was performed. Further, the copper solid sample as used above was subjected to a mass spectroscopic analysis under the same conditions as described above, except that a conventional glow discharge system illustrated in FIG. 2 was used in the glow discharge mass spectroscope. Respective site sizes were t1=0.5 mm, t2=2 mm, t3=0.5 mm, t4=0.5 mm, t5=2.0 mm, t6=0.5 mm, t7=1.5 mm, t8=1.0 mm, t11=0.5 mm, t12=1.5 mm, and t13=3.5 mm. The opening 25a had an inner diameter of 5.0 mm, and the slit 22a had a width of 0.16 mm and a length of 1.0 mm.

Copper contains Cu63 and Cu65 that are isotopes, at a mass ratio of Cu63:Cu65=7:3. For this reason, Cu63 having a high content has hitherto been measured for copper measurement. Also in this Example, a peak of Cu63 had a height of 1.0×10⁻⁹ A in a mass spectroscopic analysis using the conventional glow discharge system.

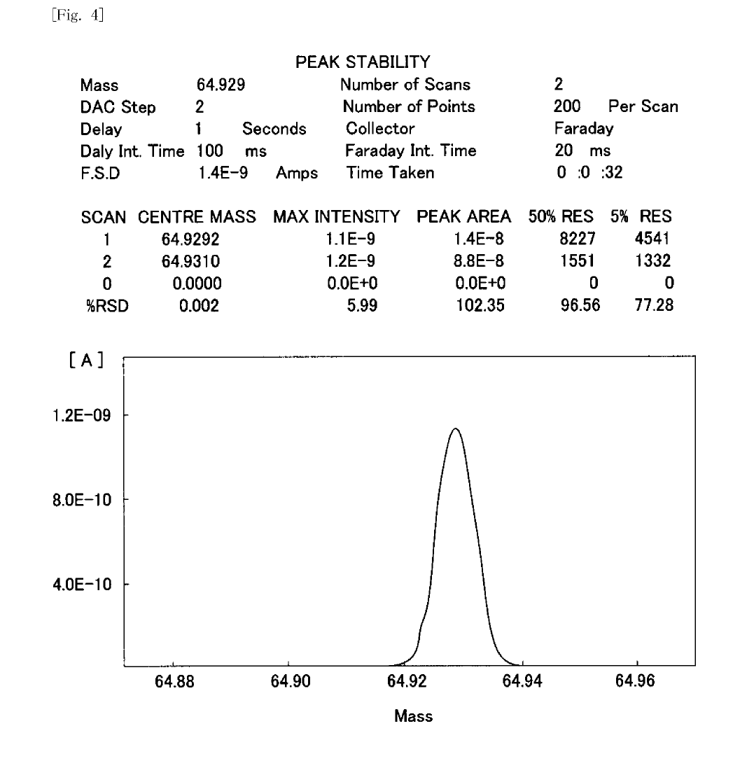

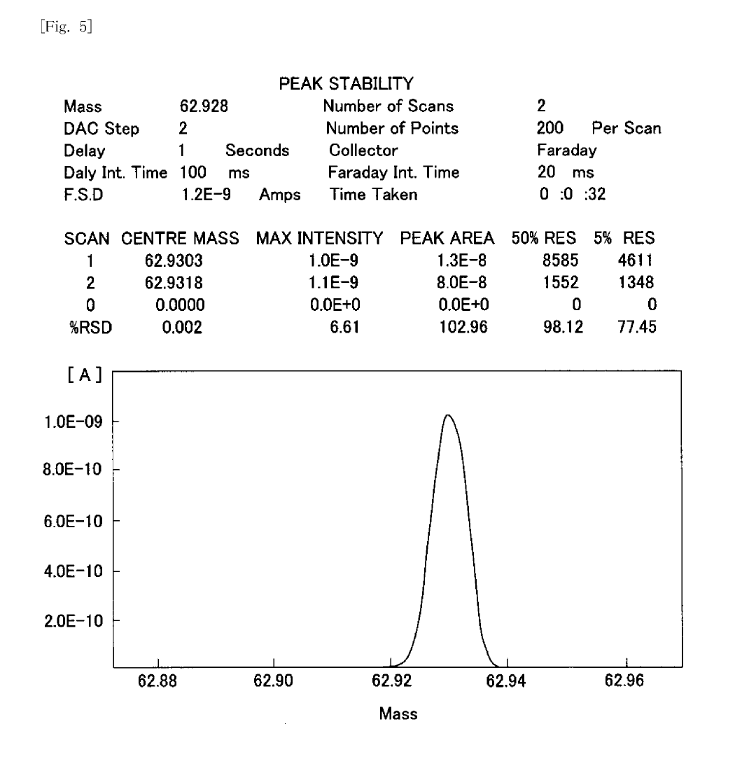

On the other hand, in a mass spectroscopic analysis using a glow discharge system of the present invention, due to an excessively high peak as a result of Cu63 measurement, Cu65 having a low content was measured for detector protection purposes. As a result, the peak had a height of 1.1×10⁻⁹ A that was 2.5×10⁻⁹ A in terms of Cu63. This height was more than twice the peak height of Cu63 measured using the conventional glow discharge system. Analysis charts for the obtained Cu65 and Cu63 are illustrated in FIGS. 4 and 5.

### EXPLANATION OF REFERENCE NUMERALS

10 Sample holder
11 Frame
12 Insulating ring
13 Sample isolator
14 Front plate
14a Opening
16 Plunger
20 Discharge cell
21 Cell body
21a Gas introduction hole
22 Slit plate
22a Slit
23, 41 End plate
23a Opening
23b Projection
24 Cell mounting plate
25, 42 Extraction plate
25a, 42a Opening
26 First plate
26a Projection
27 Discharge region
28 Second plate
30 Solid sample

1. An ion extraction structure of a glow discharge system used for a glow discharge mass spectroscope, the glow discharge system comprising:
an electroconductive cell body that forms a discharge region;
an insulating member; and
an electroconductive extraction plate having an ion extraction port, the extraction plate connected to the cell body with the insulating member provided between the cell body and the extraction plate, wherein
the extraction plate is formed of a first plate and a second plate each having an opening, and the first plate and the second plate are connected to each other so that the openings of the first and second plates form the ion extraction port,
the first plate is disposed on a side of the discharge region and has a first cylindrical projection that cylindrically projects from the ion extraction port toward the discharge region so that an inner wall of the first cylindrical projection defines the opening of the first plate, and
at least one of the first plate and the second plate has a circumferential projection projecting toward the other at a circumferential portion,
the first plate and the second plate are connected to each other at the circumferential projection so that a gap is provided between the first plate and the second plate, and
the gap which is provided between the first plate and the second plate is arranged at opening side.

2. The ion extraction structure of a glow discharge system according to claim 1, further comprising:
an electroconductive slit plate having a slit; and
an electroconductive end plate having an opening, wherein
the electroconductive slit plate and the electroconductive end plate are disposed between the cell body and the insulating member so that the electroconductive slit plate is adjacent to the cell body and the electroconductive end plate is adjacent to the insulating member, and
the end plate has a second cylindrical projection which cylindrically projects toward the extraction plate, and the second cylindrical projection is disposed such that the opening is disposed within the cylindrical projection and the cylindrical projection is spaced apart from the opening by a predetermined distance.

3. A glow discharge system comprising:
the ion extraction structure of a glow discharge system according to claim 1; and
a sample holder for holding a sample, the sample holder having an opening and connected to the ion extraction structure so that the sample holder is communicated to the discharge region of the cell body through the opening of the sample holder.

4-5. (canceled)

6. A glow discharge system comprising:
the ion extraction structure of a glow discharge system according to claim 2; and
a sample holder for holding a sample, the sample holder having an opening and connected to the ion extraction structure so that the sample holder is communicated to the discharge region of the cell body through the opening of the sample holder.

7. A glow discharge mass spectroscope comprising:
a glow discharge system that extracts ion beams of constituent atoms of a solid sample from the solid sample by glow discharge; and
a mass spectrograph that performs a mass spectroscopic analysis of ions contained in the ion beams, wherein
the glow discharge system is the glow discharge system according to claim 3.

8. A glow discharge mass spectroscope comprising:
a glow discharge system that extracts ion beams of constituent atoms of a solid sample from the solid sample by glow discharge; and
a mass spectrograph that performs a mass spectroscopic analysis of ions contained in the ion beams, wherein
the glow discharge system is the glow discharge system according to claim 6.

9. The glow discharge mass spectroscope according to claim 7, further comprising:
a magnetic field system that separates and selects target ions from the ion beams extracted from the glow discharge system; and
an electric field system that focuses energy of ion beams selected in the magnetic field system.

10. The glow discharge mass spectroscope according to claim 8, further comprising:
a magnetic field system that separates and selects target ions from the ion beams extracted from the glow discharge system; and
an electric field system that focuses energy of ion beams selected in the magnetic field system.
